(19) United States
(12) Patent Application Publication
(10) Pub. No.: US 2016/0180727 A1
(43) Pub. Date: Jun. 23, 2016

(54) STUDENT ASSESSMENT GRADING ENGINE

(71) Applicant: Xerox Corporation, Norwalk, CT (US)

(72) Inventors: Eric Michael Gross, Rochester, NY (US); Timothy Wayne Jacobs, Fairport, NY (US)

(21) Appl. No.: 14/574,963

(22) Filed: Dec. 18, 2014

(51) Int. Cl. G09B 7/02; G06K 9/62; G06K 9/20; G06F 17/27

(52) U.S. Cl. CPC G09B 7/02; G06F 17/2705; G06F 17/2765; G06K 9/6267; G06K 9/6262; G06K 9/2054

(57) ABSTRACT

A system for scoring an assessment may include a computing device having an image capture device and an image recognition engine, and a computer-readable storage medium. The storage medium may have one or more programming instructions that, when executed, cause the computing device to capture an image of a completed assessment, cause the computing device to, for each question, parse the image to identify the question and the handwritten response, determine a correct answer to the question, perform an image recognition analysis on the assessment to determine a confidence value, determine a question score for the question based on the determined confidence value and a point value associated with the correct answer, and determine a total score for the assessment. The computer-readable storage medium may have one or more programming instructions that, when executed, cause the computing device to assign the total score to the student, and generate a report.

### BACKGROUND

Some grading systems utilize intelligent character recognition (ICR) to convert hand-written or hand-marked student work into a digital format. The student work is typically scanned and the images are sent to a classification engine which determines their most probable meaning. However, ICR is a challenging task often requiring teachers to manually confirm the ICR results before assigning the student a final evaluation. This manual confirmation is labor and time consuming.

In addition, to avoid false positives, existing grading systems typically do not classify an answer as correct unless the probability associated with the answer exceeds a certain threshold value. However, this often leads to an unclear understanding of a student's (or a group of students) understanding of the underlying subject matter due to an excess of false negatives.

### SUMMARY

This disclosure is not limited to the particular systems, methodologies or protocols described, as these may vary. The terminology used in this description is for the purpose of describing the particular versions or embodiments only, and is not intended to limit the scope.

As used in this document, the singular forms “a,” “an,” and “the” include plural reference unless the context clearly dictates otherwise. Unless defined otherwise, all technical and scientific terms used herein have the same meanings as commonly understood by one of ordinary skill in the art. All publications mentioned in this document are incorporated by reference. All sizes recited in this document are by way of example only, and the invention is not limited to structures having the specific sizes or dimension recited below. As used herein, the term “comprising” means “including, but not limited to.”

In an embodiment, a system for scoring an assessment may include a computing device having an image capture device and an image recognition engine, and a computer-readable storage medium. The computer-readable storage medium may have one or more programming instructions that, when executed, cause the computing device to capture, by the image capture device, an image of a completed assessment. The completed assessment may include one or more handwritten responses of a student. The computer-readable storage medium may have one or more programming instructions that, when executed, cause the computing device to, for each question of the completed assessment, parse, by the image recognition engine, the image to identify the question and the handwritten response associated with the question, determine a correct answer to the question, perform, by the image recognition engine, an image recognition analysis on the assessment to determine a confidence value associated with the determined correct answer for the question, determine a question score for the question based on the determined confidence value and a point value associated with the correct answer, and determine a total score for the assessment by summing the determined question scores. The computer-readable storage medium may have one or more programming instructions that, when executed, cause the computing device to assign the total score to the student, and generate a report comprising one or more of the following: one or more of the question scores, one or more of the confidence values, one or more of the point values, and the total score.

In an embodiment, a method of scoring an assessment may include capturing, by an image capture device, an image of a completed assessment that includes one or more handwritten responses of a student, and for each question of the completed assessment, parsing, by an image recognition engine, the image to identify the question and the handwritten response associated with the question, determining a correct answer to the question, performing, by the image recognition engine, an image recognition analysis on the assessment to determine a confidence value associated with the determined correct answer for the question, determining a question score for the question based on the determined confidence value and a point value associated with the correct answer, and determining a total score for the assessment by summing the determined question scores. The method may include assigning the total score to the student, and generating a report comprising one or more of the following: one or more of the question scores, one or more of the confidence values, one or more of the point values, and the total score.

### BRIEF DESCRIPTION OF THE DRAWINGS

FIG. 1 illustrates an educational assessment system according to an embodiment.

FIG. 2 illustrates a flow chart of an example method of determining assessment scores according to an embodiment.

FIG. 3 illustrates an example math assessment having three questions according to an embodiment.

FIGS. 4A and 4B illustrate example neural networks according to various embodiments.

FIG. 5 illustrates a block diagram of example hardware that may be used to contain or implement program instructions according to an embodiment.

### DETAILED DESCRIPTION

The following terms shall have, for purposes of this application, the respective meanings set forth below:

An “assessment” refers to an instrument for testing one or more student skills that requires one or more handwritten answers. An assessment may be a quiz, a test, an essay, or other type of evaluation. In an embodiment, an assessment may be an instrument embodied on physical media, such as, for example, paper.

A “computing device” or “electronic device” refers to a device that includes a processor and non-transitory, computer-readable memory. The memory may contain programming instructions that, when executed by the processor, cause the computing device to perform one or more operations according to the programming instructions. As used in this description, a “computing device” or “electronic device” may be a single device, or any number of devices having one or more processors that communicate with each other and share data and/or instructions. Examples of computing devices or electronic devices include, without limitation, personal computers, servers, mainframes, gaming systems, televisions, and portable electronic devices such as smartphones, personal digital assistants, cameras, tablet computers, laptop computers, media players and the like.

An “image capture device” refers to image sensing hardware, logic and/or circuitry that is capable of optically viewing an object, such as an assessment or other document, and converting an interpretation of that object into one or more electronic signals. Examples of an image capture devices include without limitation, cameras, scanners and/or the like.

An “image recognition engine” refers to hardware, logic, memory and/or circuitry that is capable of parsing an image and converting an interpretation of at least a portion of the image content into one or more electronic signals for analysis.

Grading engines typically operate on a question-by-question level. That is, did a student answer a specific question correctly or incorrectly? However, educators may also be interested in understanding the answers at a higher level. For example, an educator may want insight into: (1) a student's overall score on an exam; (2) whether a class as a whole is mastering a subject area; and (3) whether students had difficulty answering one question in particular.

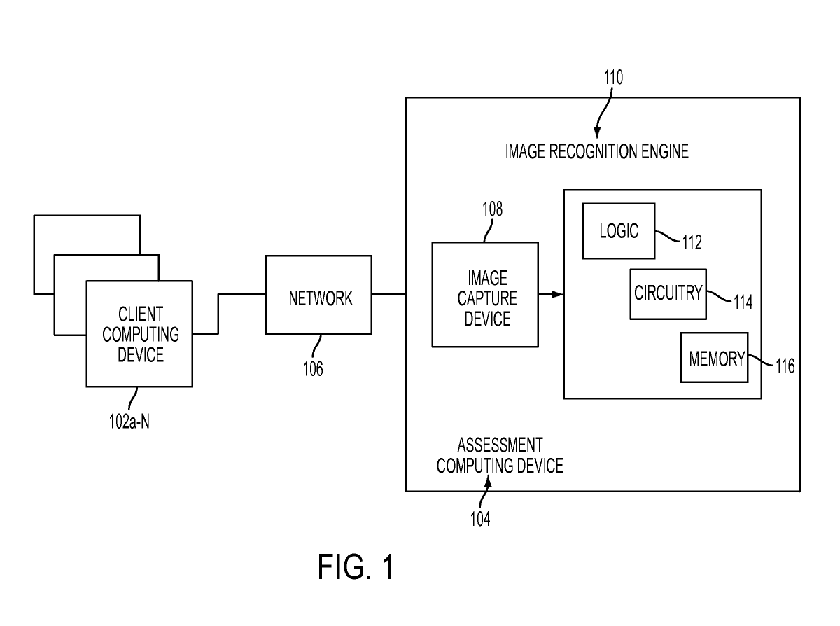

FIG. 1 illustrates an educational assessment system according to an embodiment. As illustrated by FIG. 1, an educational assessment system 100 may include one or more client computing devices 102a-N, an assessment computing device 104 and a communication network 106. As illustrated by FIG. 1, a client computing device 102a-N may communicate with an assessment computing device 104 via the communication network 106. A communication network 106 may be a local area network (LAN), a wide area network (WAN), a mobile or cellular communication network, an extranet, an intranet, the Internet and/or the like.

In an embodiment, a client computing device 102a-N may be used by an educator to access, view, change, modify, update and/or enter one or more student assessment results. A client computing device 102a-N may include, without limitation, a laptop computer, a desktop computer, a tablet, a mobile device and/or the like.

An assessment computing device 104 may be a computing device configured to receive and/or process one or more student assessments, and may include, without limitation, a laptop computer, a desktop computer, a tablet, a mobile device and/or the like. As illustrated by FIG. 1, an assessment computing device may include an image capture device 108 and/or an image recognition engine 110.

The image capture device 108 may be in communication with the image recognition engine 110. The image capture device 108 may provide a captured image as input to the image recognition engine. An image capture device 108 may be a device configured to capture an image of an assessment such as, for example, a camera, a scanner and/or the like.

In an embodiment, an image recognition engine 110 may be comprised of logic 112, circuitry 114 and/or memory 116. The logic 112 and/or circuitry 114 of the image recognition engine 110 may cause the image recognition engine to parse a received image to identify an assessment question or response, or perform image recognition analysis on the captured image as described in more detail below. Image recognition analysis may be used by an image recognition engine to determine a likelihood that one or more assessment responses are correct, incorrect and/or the like. Memory 116 may be used to store received images, determined likelihoods and/or other information. Examples of memory may be read only memory (ROM), random access memory (RAM) and/or another tangible, non-transitory computer-readable medium.

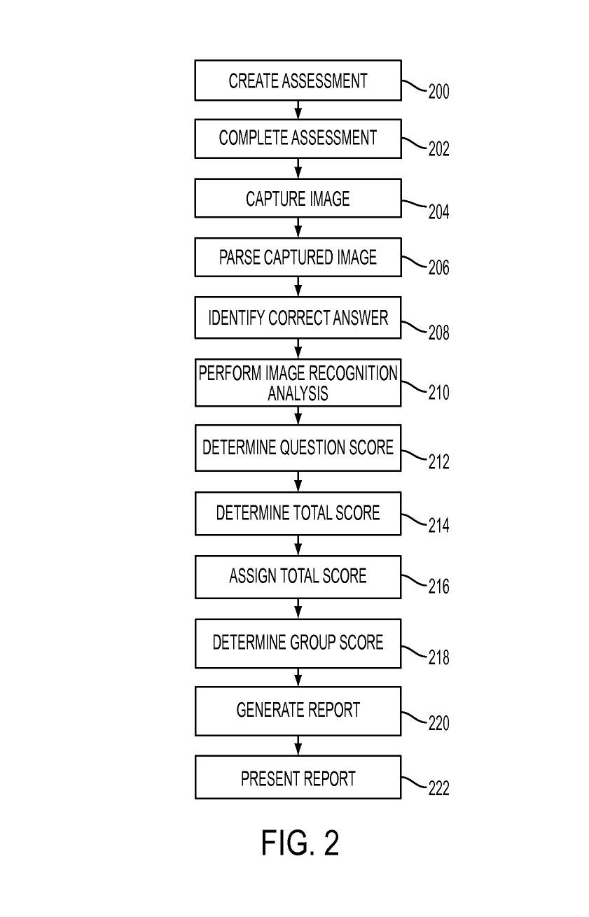

FIG. 2 illustrates a flow chart of an example method of determining assessment scores according to an embodiment. In an embodiment, a score may be predicted on a question-by-question basis or an assessment-by-assessment basis, and on a student-by-student basis, by class or other group and/or the like.

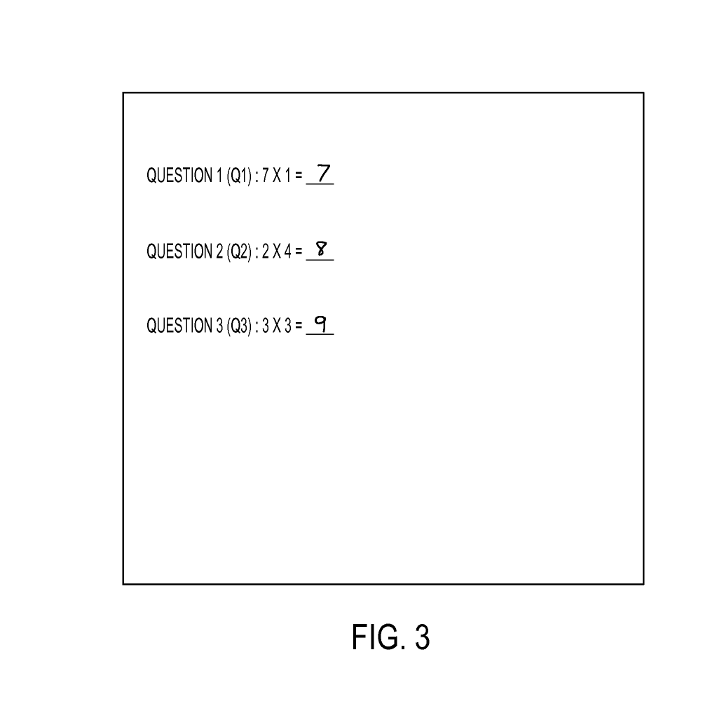

As illustrated by FIG. 2, an educator may create 200 an assessment. An assessment may be created electronically by an educator. For instance, an educator may use a word processing application or other software application to create an assessment. FIG. 3 illustrates an example math assessment having three questions according to an embodiment.

In an embodiment, the assessment may be provided to a student, and the student may complete 202 the assessment. A student may complete 202 at least a portion of the assessment by providing a handwritten answer for at least a portion of the assessment. For instance, an assessment may evaluate a student's math skills by asking the student to complete 202 certain mathematical equations. A student may complete 202 this assessment by writing answers to the equations on the assessment.

In an embodiment, the assessment may be provided as input to an educational assessment system. An educational assessment system may be a software application executing on or hosted by one or more computing devices that grades or otherwise evaluates one or more assessments. An image capture device of an educational assessment system may capture 204 an image of a completed assessment. For instance, an educational assessment system may capture 204 an image of a completed assessment through scanning, taking a picture and/or any other capturing technique.

In various embodiments, the system may parse 206 a captured image to identify a question and/or a handwritten response associated with the question. An image recognition engine may be used to parse a captured image to identify a question and/or a response to a question.

In an embodiment, the system may identify 208 a correct answer for one more questions of an assessment. A system may identify 208 one or more correct answers using an answer key associated with an assessment, receiving correct answers to one or more questions from an educator, or otherwise accessing one or more correct answers for the assessment by, for example, retrieving such answers from a computer-readable storage medium.

The educational assessment system may perform 210 an image recognition analysis, such as Intelligent Character Recognition (ICR), on a received completed assessment. In various embodiments, an image recognition engine of the system may perform image recognition analysis. In an embodiment, the image recognition analysis may be used to analyze or more of a student's written answers.

In various embodiments, the image recognition analysis may be performed to an assessment to generate one or more confidence values associated with one or more possible answers. A confidence value may reflect a likelihood that a specific handwritten answer is the correct answer. For example, the possible answer outcomes for a math assessment may be integers between 0 and 9. Table 1 illustrates example confidence information corresponding to Question 1 (Q1) of the assessment illustrated by FIG. 3 according to an embodiment. As illustrated by FIG. 3, the confidence value associated with the possible answer ‘7’ is 0.98 when the correct answer to the question is ‘7.’ In contrast, the confidence value associated with the possible answer ‘1’ is 0.02 when the correct answer is ‘7.’

TABLE 1

| Possible Answer | Confidence Value | Point Award Policy |
|---|---|---|
| 0 | 0 | 0 |
| 1 | 0.02 | 0 |
| 2 | 0 | 0 |
| 3 | 0 | 0 |
| 4 | 0 | 0 |
| 5 | 0 | 0 |
| 6 | 0 | 0 |
| 7 | 0.98 | 5 |
| 8 | 0 | 0 |
| 9 | 0 | 0 |

In an embodiment, a confidence value may be generated for each potential answer. For example, in arithmetic in which answers range from 0 to 9, a confidence value for each potential character may be generated using one or more models, statistical approaches and/or the like. For example, one or more confidence values may be generated using one or more neural networks, Bayesian methods and/or the like. For instance, the system may identify a response to an assessment question, and may use the identified response as input to a neural network. The output of the neural network may be a confidence value associated with one or more possible answers for the question.

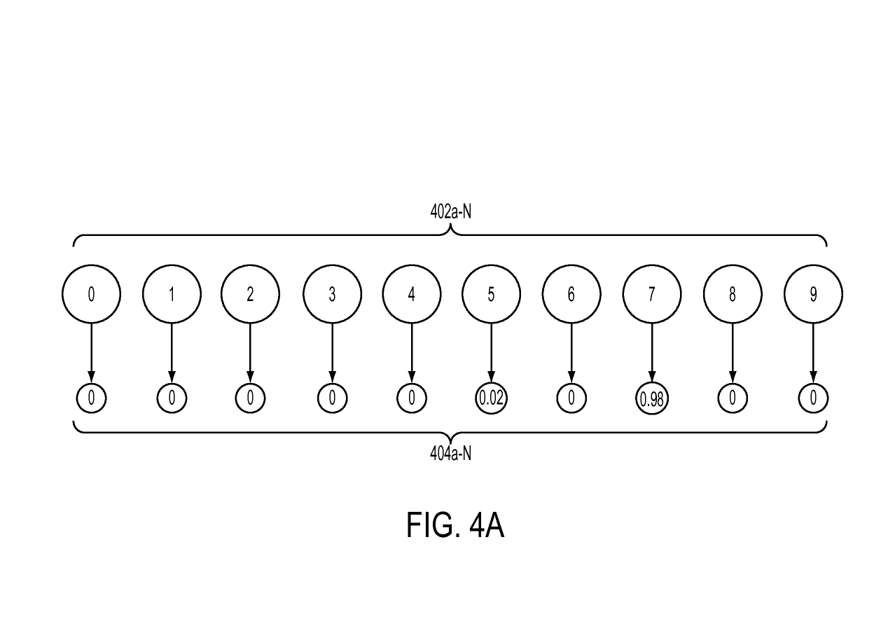

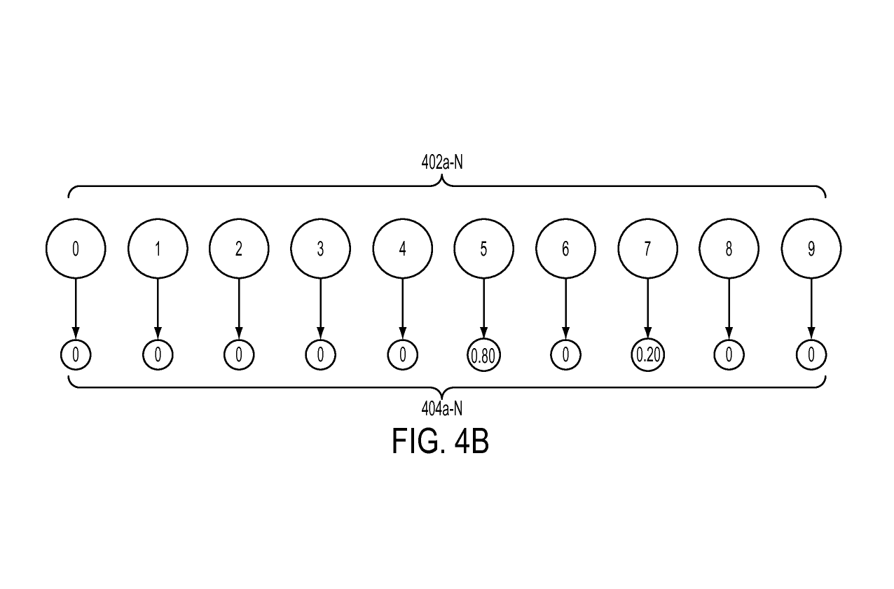

As an example, FIGS. 4A and 4B each illustrate an example neural network approach according to various embodiments. In FIGS. 4A and 4B, each node 402a-N may correspond to a possible answer. The neural network in FIGS. 4A and 4B correspond to the possible answers to Q1 of FIG. 3 according to an embodiment. As illustrated by FIGS. 4A and 4B, each possible answer may correspond to a node 402a-N, and each node may yield a confidence value 404a-N. For instance, the system may perform image recognition analysis on the assessment, and may determine a confidence value associated with one or more possible answers or nodes. With respect to FIG. 4A, a student may answer Q1 as ‘7’ and the system may identify ‘7’ as the student's response. In this situation, as illustrated by FIG. 4A, the confidence value associated with ‘7’ (0.98) is close to ‘1’, which may indicate that the likelihood that the student's written answer was ‘7’ is high. In contrast, FIG. 4B illustrates an example situation where a student answers ‘5’ to Q1 instead of ‘7.’ As such, the confidence value associated with ‘5’ (0.80) is high and close to a value of ‘1’. However, the confidence value associated with the correct answer ‘7’ (0.20), is lower.

In various embodiments, a neural network, and therefore a confidence value, may be tailored to a particular student. For example, a grading system may have access to historical assessment information for a student, such as, for example, past handwriting samples, indications of academic ability of the student in one or more areas, such as, for example, grades and/or the like.

Table 1 also illustrates a point award policy associated with each possible answer. A point award policy may indicate a number of points or other score to award to a student for the corresponding answer. In the example illustrated by Table 1, the correct answer is ‘7’ and is worth a total of 5 points. The other answers are assigned a value of zero points, indicating that no partial credit is given for wrong answers.

In an embodiment, a point award policy may be defined by an educator. For instance, an educator may specify the point award policy for a question, an assessment and/or the like in connection with creating an assessment. In an embodiment, a point award policy may be specific to a question, an assessment and/or the like.

In an embodiment, the system may determine 212 a question score for one or more questions of an assessment. A question score may refer to a score for an individual question. To avoid false positives, existing grading systems typically do not classify an answer as correct unless the likelihood probability associated with the answer exceeds a certain threshold value. However, this often leads to an unclear understanding of a student's (or a group of students) understanding of the underlying subject matter and often underestimates the true score.

The system may determine 212 a score for one or more questions based on the confidence value associated with the correct answer and a point value associated with the correct answer.

As an example, a student may complete the assessment of FIG. 3 as follows:

7×1=7 Q1

2×4=6 Q2

3×3=9 Q3

The confidence values for the correct answers to Q2 and Q3 may be illustrated by Tables 2 and 3, respectively:

TABLE 2

| Possible Answer | Confidence Value | Point Award Policy |
|---|---|---|
| 8 | 0.15 | 5 |

TABLE 3

| Possible Answer | Confidence Value | Point Award Policy |
|---|---|---|
| 9 | 0.85 | 5 |

Because the likelihood probability associated with the correct answer for Q2 and Q3 may be below the threshold value, existing grading systems may classify each of these answers as incorrect and award no points for these answers. As such, a known grading system may award a total of 5 points out of 15 points to the student, when the student's true score is 10 points out of 15 points.

The described system may determine a question score for one or more questions by multiplying the confidence value associated with the correct answer by the point value associated with the correct answer. For example, referring to the question corresponding to Table 1, a question value may be determined by multiplying the confidence value associated with the answer ‘7’ (0.98) by the total points associated with the answer ‘7’ (5) to yield a question score of 4.9 points out of five possible points.

As another example, referring to Q2 and Table 2, a question score may be determined by multiplying the confidence value associated with the answer ‘8’ (0.15) by the total points associated with the answer ‘8’ (5) to yield a question score of 0.75 points out of five possible points.

As yet another example, referring to Q3 and Table 3, a question score may be determined by multiplying the confidence value associated with the answer ‘9’ (0.85) by the total points associated with the answer ‘9’ (5) to yield a question score of 4.25 points out of five possible points.

In an embodiment, partial credit may be available for one or more questions. For example, Table 4 illustrates example confidence values and point values for a question where partial credit is available and the correct answer is ‘4.’

TABLE 4

| Possible Answer | Confidence Value | Point Award Policy |
|---|---|---|
| 4 | 0.75 | 5 |
| 9 | 0.25 | 2 |

As illustrated by Table 4, a correct answer of ‘4’ is worth 5 points. But an incorrect answer of ‘9’ is worth 2 points. When partial credit is available for a question, the system may determine a question score for the question by, for each answer for which full or partial credit is given, multiplying the confidence value and the point values associated with a particular answer, and then summing the values. For instance, with respect to the question corresponding to Table 4, a question score may be determined by: (0.75*5)+(0.25*2)=3.75+0.50=4.25 points out of 5 total points.

In certain embodiments, the system may determine 214 a total score for an assessment. A total score may be determined 214 by summing the question scores associated with one or more questions of an assessment. For example, if an assessment includes Q1, Q2 and Q3 as described above, the total score for the assessment may be equal to 9.9 points out of 15 points (i.e., 4.9 points+0.75 points+4.25 points).

In an embodiment, the system may assign 216 the total score to the corresponding student. The system may assign 216 the total score to the student by causing one or more records associated with the student and/or the assessment to reflect the total score, notifying the student and/or the educator of the total score, sending the total score to the student and/or the educator and/or the like.

In an embodiment, the system may determine 218 a group score for an assessment. A group score may be a score associated with a plurality of students such as, for example, a class, a subgroup of a class, a school and/or the like. A group score may be an average of the total scores of the students in the group. For instance, Table 5 illustrates example total scores for students in a class who completed the example assessment above.

TABLE 5

| Student | Total Score |
|---|---|
| 1 | 9.90 |
| 2 | 12.20 |
| 3 | 10.20 |

The group score associated with the group illustrated by Table 5 may be ((9.90+12.20+10.20)/3)=10.77.

In various embodiments, the system may generate 220 a report. A report may include one or more of a confidence value and/or point award policy for one or more questions, a question score for one or more questions and/or students, a total score for one or more students, a group score and/or the like. The report may include one or more graphs, charts or other visual representations.

In an embodiment, the system may present 222 a report to an educator. The report may be presented 222 to an educator via a graphical user interface, email, and/or the like. The educator may have an opportunity to change or override one or more scores illustrated in a report.

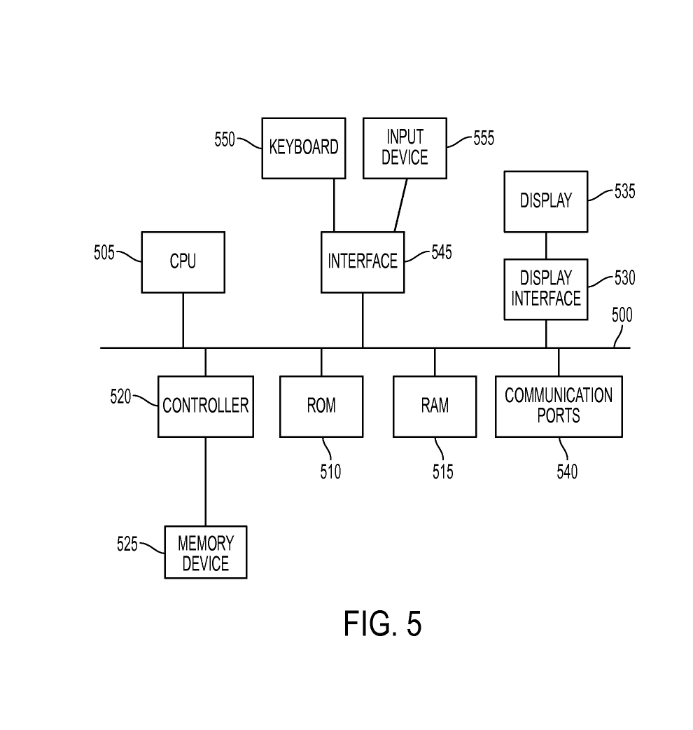

FIG. 5 depicts a block diagram of hardware that may be used to contain or implement program instructions. A bus 500 serves as the main information highway interconnecting the other illustrated components of the hardware. CPU 505 is the central processing unit of the system, performing calculations and logic operations required to execute a program. CPU 505, alone or in conjunction with one or more of the other elements disclosed in FIG. 5, is an example of a production device, computing device or processor as such terms are used within this disclosure. Read only memory (ROM) 510 and random access memory (RAM) 515 constitute examples of non-transitory computer-readable storage media.

A controller 520 interfaces with one or more optional non-transitory computer-readable storage media 525 to the system bus 500. These storage media 525 may include, for example, an external or internal DVD drive, a CD ROM drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 510 and/or the RAM 515. Optionally, the program instructions may be stored on a tangible, non-transitory computer-readable medium such as a compact disk, a digital disk, flash memory, a memory card, a USB drive, an optical disc storage medium and/or other recording medium.

An optional display interface 530 may permit information from the bus 500 to be displayed on the display 535 in audio, visual, graphic or alphanumeric format. Communication with external devices, such as a printing device, may occur using various communication ports 540. A communication port 540 may be attached to a communications network, such as the Internet or an intranet.

The hardware may also include an interface 545 which allows for receipt of data from input devices such as a keyboard 550 or other input device 555 such as a mouse, a joystick, a touch screen, a remote control, a pointing device, a video input device and/or an audio input device.

It will be appreciated that the various above-disclosed and other features and functions, or alternatives thereof, may be desirably combined into many other different systems or applications or combinations of systems and applications. Also that various presently unforeseen or unanticipated alternatives, modifications, variations or improvements therein may be subsequently made by those skilled in the art which are also intended to be encompassed by the following claims.

What is claimed is:

1. A system for scoring an assessment, the system comprising:
a computing device comprising:
an image capture device, and
an image recognition engine; and
a computer-readable storage medium comprising one or more programming instructions that, when executed, cause the computing device to:
capture, by the image capture device, an image of a completed assessment, wherein the completed assessment comprises one or more handwritten responses of a student,
for each question of the completed assessment:
parse, by the image recognition engine, the image to identify the question and the handwritten response associated with the question,
determine a correct answer to the question,
perform, by the image recognition engine, an image recognition analysis on the assessment to determine a confidence value associated with the determined correct answer for the question,
determine a question score for the question based on the determined confidence value and a point value associated with the correct answer,
determine a total score for the assessment by summing the determined question scores,
assign the total score to the student, and
generate a report comprising one or more of the following:
one or more of the question scores,
one or more of the confidence values,
one or more of the point values, and
the total score.

2. The system of claim 1, wherein the one or more programming instructions that, when executed, cause the computing device to for each question of the completed assessment, perform, by the image recognition engine, an image recognition analysis on the assessment to determine a confidence value associated with the determined correct answer for the question comprise one or more programming instructions that, when executed, cause the computing device to perform, by an intelligent character recognition engine, intelligent character recognition on the assessment.

3. The system of claim 1, wherein:
the one or more programming instructions that, when executed, cause the computing device to for each question of the completed assessment, perform, by the image recognition engine, an image recognition analysis on the assessment to determine a confidence value associated with the determined correct answer for the question comprise one or more programming instructions that, when executed, cause the computing device to perform, by a neural network intelligent character recognition engine, intelligent character recognition to the assessment,
the one or more programming instructions that, when executed, cause the computing device to determine a confidence value associated with the determined correct answer comprises one or more programming instructions that, when executed, cause the computing device to:
provide as input to a neural network the identified handwritten response, and
receive, as output from the neural network, the confidence value, wherein the confidence value indicates a likelihood that the identified handwritten response is the identified correct answer.

4. The system of claim 1, wherein the one or more programming instructions that, when executed, cause the programming device to determine a question score for the question based on the determined confidence value and a point value associated with the correct value comprise one or more programming instructions that, when executed, cause the computing device to multiply the determined confidence value by the point value.

5. The system of claim 1, wherein the one or more programming instructions that, when executed, cause the computing device to determine a question score for the question based on the determined confidence value and a point value associated with the correct value comprise one or more programming instructions that, when executed, cause the computing device to:
determine a first score by multiplying the confidence value associated with the determined correct answer and the point value associated with the correct answer;
identify one or more possible answers for which partial credit is available, wherein each identified possible answer is associated with a partial credit point value that is less than a point value associated with the correct answer;
for each identified possible answer:
determine a confidence value associated with the identified possible answer, and
determine a second score by multiplying the confidence value associated with the identified possible answer by the partial credit point value associated with the identified possible answer; and
sum the first score and the second scores.

6. The system of claim 1, wherein the one or more programming instructions that, when executed, cause the computing device to determine a total score for the assessment comprise one or more programming instructions that, when executed, cause the computing device to sum the determined question values.

7. A method of scoring an assessment, the method comprising:
capturing, by an image capture device, an image of a completed assessment, wherein the completed assessment comprises one or more handwritten responses of a student;
for each question of the completed assessment:
parsing, by an image recognition engine, the image to identify the question and the handwritten response associated with the question,
determining a correct answer to the question,
performing, by the image recognition engine, an image recognition analysis on the assessment to determine a confidence value associated with the determined correct answer for the question,
determining a question score for the question based on the determined confidence value and a point value associated with the correct answer,
determining a total score for the assessment by summing the determined question scores;
assigning the total score to the student; and
generating a report comprising one or more of the following:
one or more of the question scores,
one or more of the confidence values,
one or more of the point values, and
the total score.

8. The method of claim 7, wherein performing an image recognition analysis on the assessment to determine a confidence value associated with the determined correct answer for the question comprises performing, by an intelligent character recognition engine, intelligent character recognition on the assessment.

9. The method of claim 7, wherein:
performing an image recognition analysis on the assessment to determine a confidence value associated with the determined correct answer for the question comprises performing, by a neural network intelligent character recognition engine, intelligent character recognition to the assessment,
determining a confidence value associated with the determined correct answer comprises:
providing as input to a neural network the identified handwritten response, and
receiving, as output from the neural network, the confidence value, wherein the confidence value indicates a likelihood that the identified handwritten response is the identified correct answer.

10. The method of claim 7, wherein determining a question score for the question based on the determined confidence value and a point value associated with the correct value comprises multiplying the determined confidence value by the point value.

11. The method of claim 7, wherein determining a question score for the question based on the determined confidence value and a point value associated with the correct value comprises:
determining a first score by multiplying the confidence value associated with the determined correct answer and the point value associated with the correct answer;
identifying one or more possible answers for which partial credit is available, wherein each identified possible answer is associated with a partial credit point value that is less than a point value associated with the correct answer;
for each identified possible answer:
determining a confidence value associated with the identified possible answer, and
determining a second score by multiplying the confidence value associated with the identified possible answer by the partial credit point value associated with the identified possible answer; and
summing the first score and the second scores.

12. The method of claim 7, wherein determining a total score for the assessment comprises summing the determined question values.
